(19) United States
(12) Patent Application Publication
(10) Pub. No.: US 2012/0273635 A1
(43) Pub. Date: Nov. 1, 2012

(54) UNIVERSAL LOADING DEVICE

(76) Inventor: Jonathan Scott Byler, San Jose, CA (US)

(21) Appl. No.: 13/098,403

(22) Filed: Apr. 30, 2011

(51) Int. Cl. F16B 47/00

(52) U.S. Cl. 248/205.5; 248/205.1; 294/183

(57) ABSTRACT

Disclosed herein is an apparatus for assisting workers moving large and heavy containers designed for long distance travel, especially container travel in an airplane. The subject invention is a universal loading device (ULD) including an angle bracket. The angle bracket having a first arm, defining, in use, a handle. The angle bracket having a second arm, which is generally perpendicular to the first arm. Attached to the second arm is an attachment member for attaching the ULD to a container. Typically, the attachment member includes a suction cup or other simple mechanical suction device. In order to guide the ULD of this invention to its desired place on the container, a support member is connected to the ULD. The support member has a portion for contacting the container, which is generally smooth to prevent damaging the container. Additionally, the support member has thickness approximately equal to the thickness of the deformed suction cup.

### FIELD OF THE INVENTION

This invention relates generally to the field of apparatus used for loading heavy containers in a cargo vessel specifically designed for containers. More particularly, this invention relates to unit load devices for loading cargo containers onto airplanes, boats, train, trucks and the like which transport large and heavy cargo containers great distances.

### BACKGROUND OF THE INVENTION

Moving heavy objects from one point to another can become a complicated issue. Especially, when those objects have no handles and are to be placed in a restricted space environment. For example, when a shipping company hauls packages across the country or internationally, they place the packages in a cargo container designed to fit on an airplane or other restricted space. The container must be placed precisely in order to maximize the load being carried. The rising costs of fuel and the poor economic conditions in the transport industry have created a need to be efficient like never before.

It will be appreciated even by a non-expert that precision loading and placement of container weighing typically 6,000 pounds and having no handles is a complicated matter requiring not only great strength, but also skill. And indeed, even with the requisite strength and skill, great care must be taken in order to avoid worker injury. Additionally, typically shipping company, like FEDEX are on an extremely tight time schedules. The failure to follow the time schedule can not only cost a worker his job, but may result in unprofitability for the company and in turn, loss of jobs and even worse economic conditions.

Clearly, if such container had handles the movement of them would be greatly facilitated. However, handles themselves may well present a danger because such a handle can puncture the container or even the skin of an airline fuselage. It would mean that all containers would need to comply with certain rules and regulations to create safety. Further, handles could fatigue after usage rendering them a hazard or the container useless.

Thus, having a permanent handle on such containers may well prove to be worse than not having one at all. In any case, the risks of having such permanent handles are clearly unacceptable. In any case, for these and other reasons, well known by those expert in the art of building and using such containers, at this time, no permanent handles exist on containers.

As shown in FIG. 1 of the drawing, containers are loaded onto the cargo space of an airline fuselage and made to fit precisely in a certain location. The containers are locked in place as shown. It will be appreciated that the containers themselves are normally fully loaded and are quite heavy. Thus, moving the containers from one point to another is not an easy or simple matter. Further, moving the containers to a precise location as required in restricted spaces such as the cargo portion of an airline fuselage creates even more issues.

As noted above, such containers get are typically, 6,000 pounds. However, they range in weight from 200 to in excess of 9,000 pounds.

As can be imagined, moving such a container without handles requires a tremendous amount of manpower or strength. Precision placement of the heavy container further complicates matters. And, indeed, the added factor of having to do all of the above in an almost inhumanly amount of time, really makes such loading and unloading of these cargo containers a task that requires not only strength, but also skill.

And, the final factor to weigh into the heavy container movement issue is safety. It does not good for a company to load such heavy containers efficiently and timely, if workers are being injured. Worker safety is always a company's first concern, if not for the humanitarian reasons, but the cost of work injury and workman's compensation insurance.

Organizations, like FEDEX or UPS or other shipping companies require not only efficient loading and unloading of such containers, but also demand workers have a safe, injury free environment. While organizations such as FedEx or UPS can't exist without making a profit, such companies cannot exist if workers are being injured.

It is only human nature in such cases, for workers to take risks and strain themselves to the point of injury in order to get the loading and/or unloading done in the fastest time possible. Worker bonuses, raises, and overall company health depend upon workers getting the loading/unloading done in the fastest time possible.

Thus, what is needed is a device and method, which allows workers to load/unload handle-less heavy containers in a restricted space environment in a safe and efficient manner.

### SUMMARY OF THE INVENTION

A universal loading device (ULD) is provided to assist workers in loading cargo containers without permanent handles in restricted loading space. The ULD, in accordance with this invention, provides a removable handle for assisting in moving the container from one location to another with the precision needed. The ULD includes a bracket defining a handle, means for attaching the ULD to the container and a support member for supporting the ULD once attached to the container. In an exemplary embodiment, the device includes a trigger for releasing the ULD from the container.

It is an object of this invention to provide an apparatus, which facilitates the movement of the container into the correct location for travel.

It is an additional object of this invention to provide such an apparatus, which facilitates workers in being highly efficient in moving cargo containers from one location to another within tight confines of a cargo vessel.

It is an additional object of this invention to provide such an apparatus, which facilitates movement of the cargo container into the correct location, while allow efficient, but also safe movement of such a container.

It is an advantage of this invention to provide a simple, yet effective apparatus for facilitating moving heavy containers without permanent handles.

It is another advantage of this invention to a provide a simple, yet effective apparatus described herein which not only facilitates moving heavy containers without permanent handles, but allows the workers to do so in an efficient and safe manner.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective view of multiple containers loaded into the cargo area of an airline.

FIG. 2 is a perspective view of an exemplary embodiment of the invention, a universal loading device.

FIG. 3 is a side view of the exemplary embodiment of the invention shown in FIG. 1.

FIG. 4 is a side view of the exemplary embodiment of the invention shown in FIG. 1 being attached to a container, providing the container with a temporary handle.

FIG. 5 is a side view of the exemplary embodiment of the invention shown in FIG. 1 attached to a container.

FIG. 6 is a perspective view of a second exemplary embodiment of the invention shown having a trigger member for releasing the ULD.

FIG. 7 is a partial cross-sectional view of the second exemplary embodiment of the invention illustrating a close-up of the trigger member.

FIG. 8 illustrates the second embodiment of the ULD attached to a container.

FIG. 9 illustrates the second embodiment of the attached ULD1 being removed from the container.

### DETAILED DESCRIPTION OF THE INVENTION

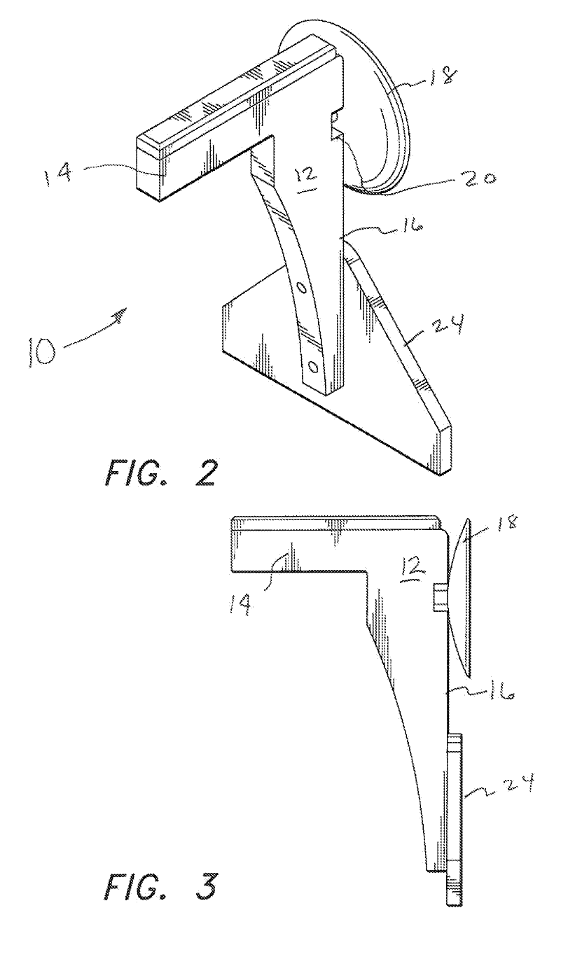

In order to appreciate the invention herein, one must appreciate the need in the art as set forth in the Background. The structure herein for resolving the long felt need to facilitate improved loading and unloading of heavy cargo containers in a restricted space, the instant invention, is a universal loading device, ULD, generally indicated by the numeral 10 in FIG. 2.

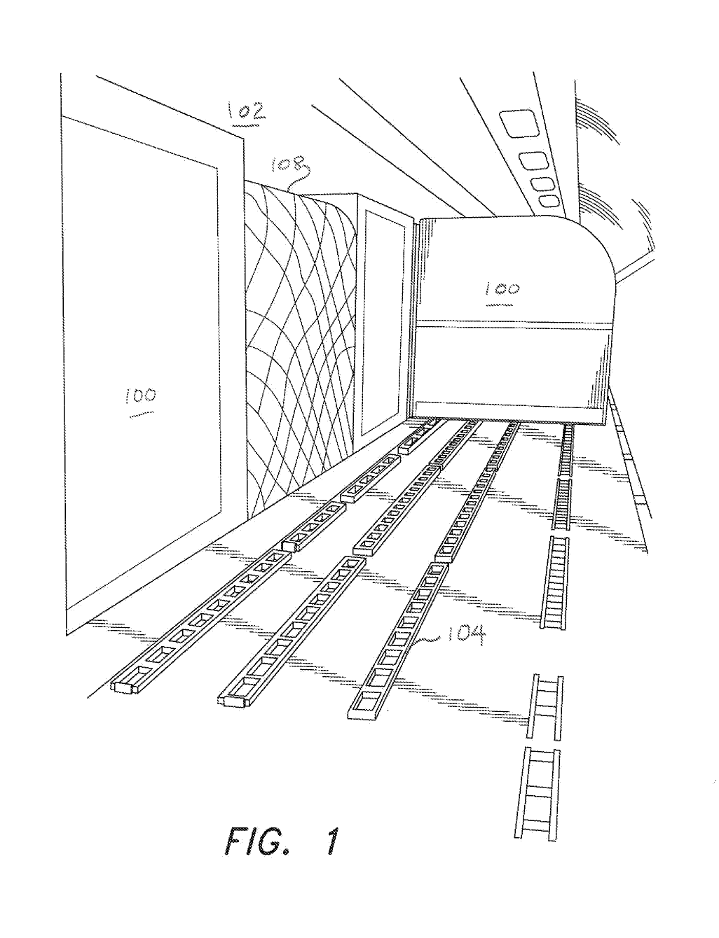

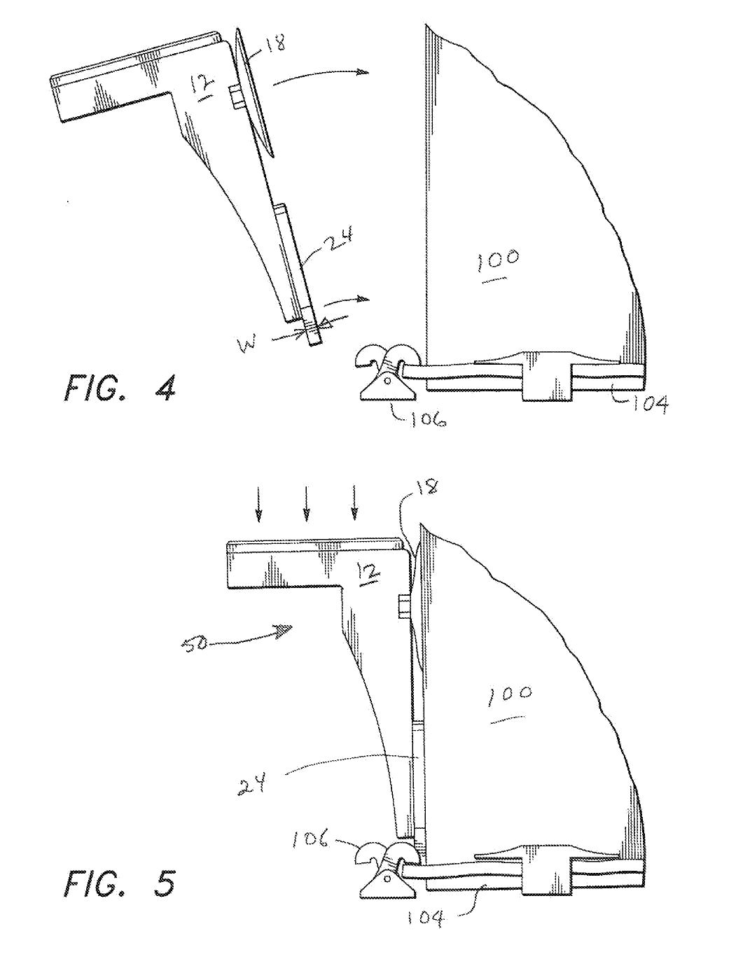

The invention will now be described with respect to the first exemplary embodiment, illustrated in FIGS. 2 through 5 as applied to its work environment, shown in FIG. 1. As a preface to the description of the ULD 10, in accordance with the invention, the cargo space environment will now be described.

As illustrated in FIG. 1, containers 100, are placed in an airline fuselage 102. In order to load or unload containers 100 into the fuselage 102 tracks 104 are provided on the floor of the fuselage 102. The containers 102 are loaded, individually onto the tracks 104 and then moved into position. Typically, the tracks 104 have rollers or roller bearings enabling the containers 100 to glide along the tracks 104. As shown in FIGS. 4 & 5, the tracks 104 include locks 106.

Each of the containers 100 must be properly positioned to maximize the number of such containers 100 that can be loaded into the cargo space of the fuselage 102. Once positioned for maximum cargo carrying, the containers 100 must then be precisely located relative to the locks 106 so that each container is locked in placed.

In addition to maximizing the number of containers 100 loaded into the cargo space of the fuselage 102, the workers loading such containers must work around airplane structures such as bulkhead and conduit and the like. As illustrated in FIG. 1, two such containers 100 are positioned on either side of a bulkhead 108.

As noted earlier, moving the heavily loaded containers in place is no simple matter. Great care must be taken to insure that the movement is done correctly without damage to the container or its contents and without injuring a worker. All of which, are made more complex when time is a major concern. As noted earlier time is the difference between making a profit and a healthy company and a company that cannot compete in the market place.

FIGS. 2-5 illustrate a first exemplary embodiment of the invention shown generally by the numeral 10, a universal loading device, ULD. The ULD 10 includes an angle bracket 12 having a first arm 14 and a second arm 16. The first arm 14 is perpendicular to the second arm 16.

The ULD 10 additionally includes a suction cup 18, which provides a means for the ULD 10 to be temporarily attached to the container 100. The suction cup 18 is connected to the angle bracket 12 through a notch 20 in the second arm 16. The suction cup 18 includes a nipple 22, which is force fit into the second arm notch 20. It will be, of course, appreciated that any means of connection of the suction cup 18 to the angle bracket 12 is within the spirit and scope of the invention provided it performs in generally the same manner as described and illustrated herein.

The ULD 10 additionally includes a support member 24. The support member 24, in use, FIGS. 4 & 5, abuts against the side of the container 100. As the ULD 10 is secured to the container 100, FIG. 5, the support member is used as a guide and a spacer. The support member 24 is connected to the second arm 16.

With particular reference to FIGS. 4 & 5, there is shown the first exemplary embodiment in use. The ULD 10 is moved against the side surface of the container 100. Continued pressure of the ULD 10 against the side surface of the container 100, deforms the suction cup 18 as shown clearly in FIG. 5. When the suction cup 18 is fully deformed and the air has escaped therefrom a temporary bond exists between the ULD 10 and the container 100. It will be appreciated that the thickness of the angle bracket 12 or its width “w” equals the width of the fully deformed suction cup.

In preserving this width “w” during operation the ULD forms a right angle connection with the container 100. Thus, by doing so, only a generally flat surface defining the support member 24 and the suction cup 18 contacts the surface of the container. Thus, despite using force while moving the container 100, no damage to its surface results because no sharp edge of the ULD 10 contacts the container 100.

When attached, as illustrated in FIG. 5, the ULD and more particularly the first arm 14 defines a handle 50 by which the container may be moved about the cargo area. As illustrated, the worker can exert downward force to the container to, in some instances, lift the container 100, over broken locks or other articles in the path of the tracks 104. The worker simply exerts a downward force on the first arm 14 as illustrated and the problem is resolved.

Similarly, in order to position the container 100 into its correct loading position. One simply moves the container 100 on the tracks 104 provided and movement is made easy and with fewer workers than previously required. Additionally, it takes less time and is far safer because less force is required and the time to complete loading is far less.

In accomplishing the above, an exemplary embodiment of the suction cup 18 is made from a deformable material, which holds its elasticity over long periods of time. Such materials include rubber, EPDM rubber. These and other materials suited for use with the invention herein are specifically formulated for outdoors use and are resistant weather aging. The angle bracket 14 is made from a strong material such as steel or other acceptable materials such as Aluminum alloys and/or carbon fibers. Similarly, the support bracket 24 is made from the same materials.

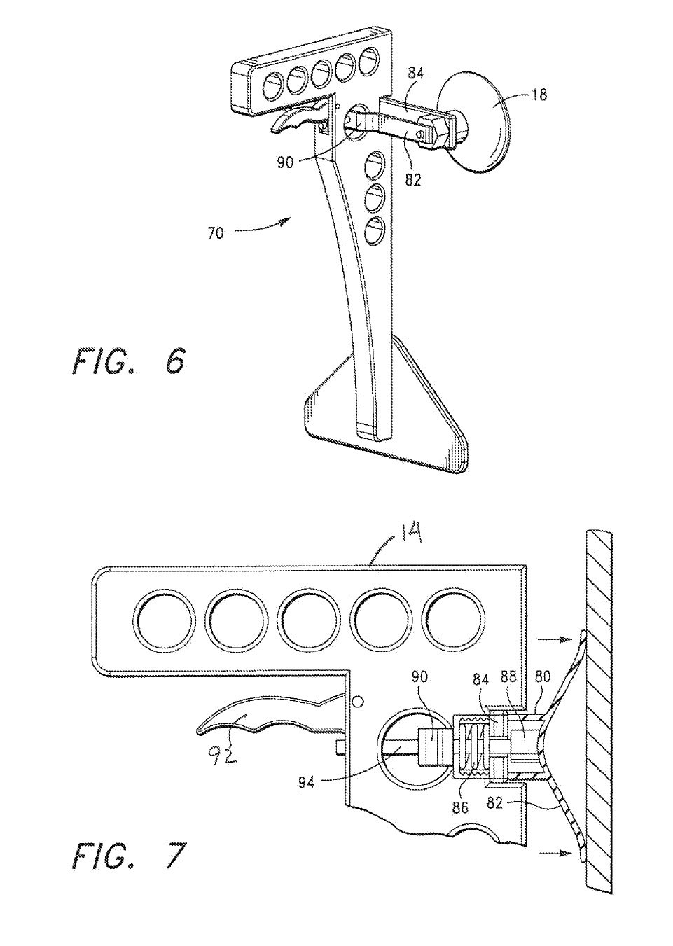

With respect to FIGS. 6-9, there is shown the second exemplary embodiment of the ULD in accordance with the invention, generally denoted by the numeral 70. The ULD 70 works in generally the same manner as the ULD 10 with the exception that ULD 70 has a trigger member 80 and the trigger member 80 includes the structure for attaching the ULD 70 to the container 100.

Illustrated in FIG. 7, in close up, is the trigger member 80. The trigger member 80 includes the attachment member 82. In this exemplary embodiment, the attachment member includes a cross bar 84 and having a suction cup 18 on either side (not shown). The trigger member 80 includes a spring 86 and a plunger 88 and a second cross member 90. A trigger handle 92 is hingedly connected (not shown) to the plunger 88 through a plunger extension 94.

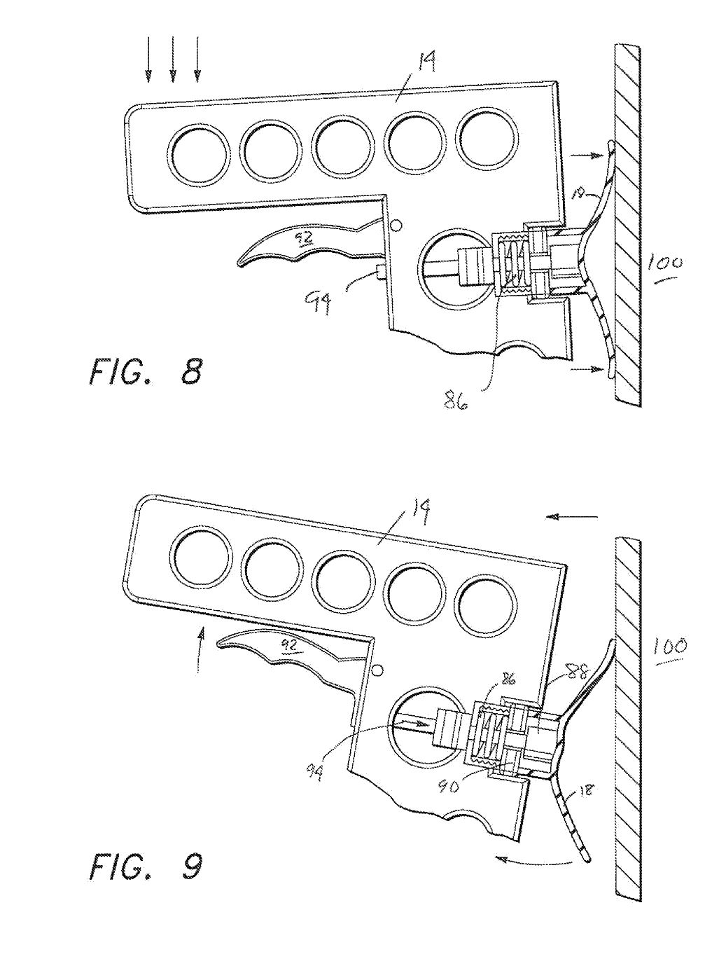

Upon attachment of the ULD 70 to the container 100, the plunger 88 moves to a normally outwardly urged position while the suction cups 18 bond, temporarily with the side surface of the container 100. (FIG. 8). Once secured to the side of the container 100, the suction cups 18, deform as illustrated and the plunger travels locking the trigger handle 92 in a position to be activated.

Once the ULD 70 is secured to the container 100, it operates in a like or even identical manner described earlier.

In order to release the ULD 70 from the container, the trigger handle 92 is activated. The trigger handle 92 is squeezed toward the first member 14 thrusting the plunger 88 into the outside surface suction cup 18 and thereby assisting the worker in breaking the seal between the container 100 and the ULD 70.

As can be appreciated upon re-attachment of the ULD 70 to another or even the same container 100, the trigger member 80 is reloaded and ready for activation. Since there is little of no wear and tear on the mechanism, the trigger member has the expectation of great reliability and long life.

While the foregoing detailed description has described several embodiments of the ULD in accordance with this invention, it is to be understood that the above description is illustrative only and not limiting of the disclosed invention. Particularly, there are different materials and dimensions of the various elements that are all within the spirit and scope of the invention. It will be appreciated that the embodiments discussed above and the virtually infinite embodiments that are not mentioned could easily be within the scope and spirit of this invention. Thus, the invention is to be limited only by the claims as set forth below.

What is claimed is:

1. A universal loading device (ULD) for assisting in the loading and transport of containers, the handle comprising:
an angle bracket having a portion defining a handle;
means for attaching the ULD to a container; and
support means for abutting the container,
whereby upon attachment of the ULD to the container, a handle is provided for moving the container, even with the container having a heavy load.

2. The ULD as set forth in claim 1, wherein the bracket includes a first arm and a second arm, perpendicular to the first arm, the first arm defining a handle.

3. The ULD as set forth in claim 2, wherein the attachment means includes a suction device attached to the second arm for attachment of the ULD to the container.

4. The ULD as set forth in claim 2, wherein the ULD includes a support member for abutting the container, the support member attached to the second arm.

5. The ULD as set forth in claim 1, wherein the attachment means includes a deformable suction cup to the second arm for attachment of the ULD to the container, upon attachment to the container the deformed suction cup spacing the ULD a distance “t” away from the attached container.

6. The ULD as set forth in claim 5, wherein the support means has a thickness “t” such that the second arm is generally parallel to the side of a container upon attachment.

7. The ULD as set forth in claim 1, wherein the support means has an abutment surface for contacting the contacting the container and wherein that abutment surface is generally smooth, so as to prevent damage to the container from ULD, when the ULD is attached.

8. A universal loading device (ULD) for assisting in the loading and transport of containers, the handle comprising:
an angle bracket having a portion defining a handle;
means for attaching the ULD to a container;
support means for abutting the container; and
a trigger member for releasing the attachment member from the container,
whereby upon attachment of the ULD to the container, a handle is provided for moving the container, even with the container having a heavy load.

9. The ULD as set forth in claim 8, wherein the bracket includes a first arm and a second arm, perpendicular to the first arm, the first arm defining a handle.

10. A universal loading device (ULD) as set forth in claim 9, wherein the trigger member is normally urged to the unactuated position, upon actuation of the trigger, the attachment member is released from the container.

11. A universal loading device (ULD) as set forth in claim 10, wherein the trigger member is spring loaded and including a plunger, which is normally urged away from the attachment member.

12. A universal loading device (ULD) as set forth in claim 11, wherein the trigger member is connected to the second arm.
